(19) United States
(12) Patent Application Publication
(10) Pub. No.: US 2015/0218854 A1
(43) Pub. Date: Aug. 6, 2015

(54) DOOR HANDLE UNIT HAVING A SAFETY FUNCTION

(71) Applicant: Huf Hülsbeck & Fürst GmbH & Co. KG, Velbert (DE)

(72) Inventors: Dirk Müller, Essen (DE); Markus Bartels, Mulheim (DE); Reinhold Mathofer, Wulfrath (DE); Ralf Lennhoff, Hagen (DE); Timo Hoppe, Wulfrath (DE); Mario Christensen, Mulheim (DE); Andreas Beck, Bochum (DE)

(21) Appl. No.: 14/421,892

(22) PCT Filed: Aug. 16, 2013
(86) PCT No.: PCT/EP2013/067178

§ 371 Date: Feb. 16, 2015

(30) Foreign Application Priority Data
Aug. 16, 2012 (DE) 10 2012 016 184.0

(51) Int. Cl. E05B 85/10

(52) U.S. Cl. CPC E05B 85/10

(57) ABSTRACT

The invention relates a door handle unit (10) for actuating a lock (101) of a movable part (100) of a motor vehicle, particularly a door, a flap or the like, with a door handle (11), which is movably mounted at the support element (12) for mechanically opening the movable part (100) by a user, wherein the door handle (11) comprises at least a rest position and a operative position, a mechanical coupling element (13), which is movably mounted at the support element (12) and by which a movement of the door handle (11) is transmitted to the lock (101) from the rest position to the operating position, wherein the door handle (11) and the coupling element (13) are mechanically cooperating and form a movable actuating mechanism (15), and at least a locking unit (16), which in a normal case enables a movement of the actuating mechanism (15) for actuating the lock (101) and only in a case of locking blocks a movement of the actuating mechanism (15) for actuating the lock (101).

According to the invention it is provided that the blocking unit (16) can be activated for a case of blocking (Ib) via a remarkable movement of the actuating mechanism (15).

The present invention is directed to a door handle unit for actuating a lock of a movable part of a motor vehicle, particularly a door, a flap or such according to the preamble of claim 1. Thereby the door handle unit comprises a door handle which is movably supported on a support element for the mechanical opening of the movable part by a user, wherein the door handle can at least take a resting and an operating position. Moreover, the door handle unit is supplied with a mechanical coupling element, which is movably supported on the support element, and is transferable by a movement of the door handle from the resting position into the operating position towards the lock, wherein the door handle and the coupling element are mechanically cooperating and form a movable actuating mechanism. Moreover, the door handle unit comprises at least a blocking unit, which in the normal case enables a movement of the actuating mechanism for actuating the lock and only in the blocking case blocks a movement of the actuating mechanism for actuating the block. Further, the present invention is also directed to a method for securing a door handle unit according to the preamble of claim 17.

From the state of the art generic door handle units are known, which comprise a crash lock or crash latch. In this context for example the document DE 199 29 022 A1 has to be mentioned, which discloses a crash lock for a generic door handle unit. The particularity of this crash lock is that it is supplied with a low mass, so that it is faster movable due to the low mass inertia as the heavier movable parts of the door handle unit. If now accelerations due to a crash act on the door handle unit, they cause that initially the fast crash lock blocks the other heavier movable parts of the door handle unit in a formfitting way. Thereby it can be avoided that an accidental deployment of the door handle unit in a crash and consequential resulting accelerations occur.

However, it has turned out with multiple crash investigations that such crash locks can flutter, so that nevertheless an undesired release of the door handle unit can occur, what in any case has to be avoided. With the previously described crash lock for the door handle unit it does not depend on whether the movable door handle itself is actually moved or not, since the crash lock is solely actuated due to impacting forces from the crash acceleration, which are directly acting on the crash lock.

An object of the present invention is to provide a door handle unit and a method for securing a door handle unit, which possess an improved security, particularly in a crash case or during an accident. Particularly, it is an object of the present invention to directly block the movement of the actuating mechanism from the door handle and the coupling element if these are unintentionally moving during a crash.

The present invention is solved by a door handle unit for actuating a lock of a movable part of a motor vehicle, particularly a door flap or such with the features of claim 1, particularly from the characterizing clause. Moreover, for solving the objections a method for securing such a door handle unit with the features of claim 17, particularly from the characterizing clause, is proposed. In the depending device and method claims preferred improvements of the invention are specified. Features which are disclosed for the door handle unit according to the invention thereby apply also for the safety method according to the invention and vice versa. Moreover, the method according to the invention from claim 17 can be realized with a door handle unit according to the invention. Advantageous embodiments of the door handle unit according to the invention and the method according to the invention are specified in the depending claims.

With the door handle unit according to the invention according to the preamble of claim 1 it is intended that the locking unit is activatable for the blocking case by a remarkable movement of the actuating mechanism. Thereby the blocking unit is not activated as itself by the crash, but only in the case if the actuating mechanism performs a remarkable movement. Thereby the blocking unit is activated by the movement of the activating mechanism and not by the acting accelerations to the door handle unit, which are present in case of a crash. By a remarkable movement of the actuating mechanism it is understood within the scope of the invention that it is fitful and/or fast. Accordingly, the remarkable movement is not based on a normal movement of the door handle in order to open the movable part like a door or a flap. However, the locking unit is activated meaning without an accident if the user for example rips or fitfully pulls the door handle. In such a case the crash unit would, like described in document DE 199 29 022 A1, not lead to a blocking of the actuating mechanism, since no direct accelerations act on the crash lock. Thereby it is clear that the present blocking unit is not activated due to crash accelerations, which are acting on a motor vehicle during crash, but by an actual relative movement of the actuation mechanism to the supporting element or movable part. Thereby the remarkable movement is solely based on a relative movement of the actuating mechanism towards the support element or movable part. A normal movement of the door handle by its user, however, does not lead to an activation of the blocking unit, so that the whole door handle unit is unrestrictedly usable and functional. The previously described case represents the normal case during an actuation of the door handle unit.

With the door handle unit according to the invention it can be intended that the blocking unit comprises at least one movable blocking latch which formfittingly blocks the actuating mechanism in a blocking case. Hereby the resulting formfit, particularly between the blocking latch and the support element or the movable part, particularly an outlet or a projection thereof, is realized. Thereby the door handle unit according to the invention is securely blocked via an occurring formfit in the activating state of the blocking unit. Thereby also a further movement of the actuating mechanism is excluded, so that no further accidental deployment can occur.

Further, it can be intended in the scope of the door handle unit according to the invention that at least a blocking latch can be transferred from the releasing position in the blocking position via a releasing force. In the release position the blocking unit resides in the normal case, so that the door handle unit according to the invention can be safely normally actuated in order to open the lock at the movable part. In the blocking position the blocking unit is in the case of emergency (the so called case of blocking), so that the blocking latch formfittingly blocks the actuating mechanism. Thereby a normal actuation of the actuating mechanism is excluded, so that the lock cannot be opened at the movable part. The previously described releasing force results from the remarkable movement of the actuating mechanism, which leads to a swinging and/or pivoting movement of the blocking unit. By this swinging and/or pivoting movement of the blocking unit a centrifugal force acts on the blocking unit, particularly on the blocking latches, so that the centrifugal force represents the releasing force for the latches. By the impact of the releasing force the blocking latches are transferred from their releasing positions to their blocking positions by pivoting. In the blocking position each a mechanical stop for each blocking latch is intended, so that these cannot be overwinded or stays in the blocking position at least during the impact of the releasing force.

Likewise, it is possible within the scope of the invention that at least a blocking latch of the blocking unit is mounted in the releasing position via a spring element. By this spring element the blocking latch is forced into the releasing position. In case of blocking the releasing force acts on the blocking latch in a way that this acts against the spring force of the spring element and the blocking latch is transferred from the releasing position into the blocking position. The corresponding spring element can be shaped as a leave spring or torsion spring and particularly about a pivoting point of the blocking latch. By the use of the spring element it can be ensured that after a blocking case the blocking latch is transferred from the blocking position back into the releasing position by a spring load as soon as the door handle is transferred to its resting position and also the corresponding actuating mechanism has taken its resting position. Subsequently the door handle unit according to the invention can be usually used (meaning subsequent to the blocking case). Thereby also rescue workers are able to free passengers from a motor vehicle in a simple manner after an accident.

Moreover, it is possible within the scope of the invention that at least a blocking latch of the blocking unit during a change from the releasing position into the blocking position mechanically locks in the blocking position via a locking connection. Thereby the blocking unit permanently blocks an actuation of the actuating mechanism with a generated form fit, so that an undesired release of the lock for opening the movable part is prevented in a secure manner. With this embodiment the door handle unit is, however, after a unique release or activation of the blocking unit not actuatable anymore by the door handle in order to open the lock for the movable part. However, this embodiment comprises the advantage that a flutter of the blocking unit according to the invention can be safely prohibited since the blocking latch is unalterable formfittingly blocked by the available snap-on connection.

According to the invention one or multiple blocking units can be intended with the door handle unit. A blocking unit can thereby comprise one or multiple blocking latches. A blocking unit can also comprise a modular composition, so that for example it can be clipped-on an actuating mechanism. Further, it is also possible that the blocking unit is engaged in a recess in the actuating mechanism, whereby the complete function of the handle unit according to the invention can be established.

Further, the door handle unit according to the invention can additionally comprise at least a crash lock, like described in the state of the art of DE 199 29 022 A2. Further, it is appropriate if a door handle unit according to the invention also comprises a counter balance weight, which is ideally mechanically connected with or even integrated in the coupling element.

With the door handle unit according to the invention it can be intended that the blocking unit is mounted directly at or with the actuating mechanism. Thereby no additional transmission element is necessary in order to move the blocking unit, since it is directly connected with the actuating mechanism and thereby the movement of the actuating mechanism directly acts on the blocking unit.

Likewise, it is possible that the blocking unit is indirectly connected with an actuating mechanism and mechanically cooperates with a transmission element. In case the blocking unit is indirectly connected with an actuating mechanism, it can comprise a separate housing, in which a movable rocker is assembled about a pivoting point or a pivoting access. Ideally the housing is stationary assembled at the door handle unit or at the movable part. Within the housing then the previously described T-like rocker is pivotably mounted at or in the housing. Moreover, at least one outlet is assembled in the housing with which the blocking latch formfittingly cooperates in a blocking case or it's blocking position. At the rocker then at least a blocking latch, preferably two blocking latches, are assembled, which in the blocking position commits the desired formfit, particularly with an outlet in the housing. The movement of the actuating mechanism can be transferred to the rocker of the blocking unit via a transmitting element wherein the transmitting element is particularly performed as a Bowden cable or chain or the like. The advantage of the indirectly assembled blocking unit is to be seen in that it can be assembled at a random position of the door handle unit or even at the movable part.

Likewise it is possible with the indirect assembly of the blocking unit with the actuating mechanism that the movement of the actuating mechanism does not only occur via the transfer element, but that additionally a translation unit, particularly in form of a gear, is intended. Hereby the translation relation can be optimized in order to, for example, achieve a fast activation of the blocking unit by means of a minimal movement of the actuating mechanism. The previously described gear can be shaped as a lever gear, gear wheel or such in order to alternate the translation relation of the movement of the actuating mechanism to the blocking unit.

Likewise, the present objection of the invention can be solved by a method for securing a door handle unit 10 according to the preamble of claim 17. Hereby it is intended according to the invention that the blocking unit is activated for a blocking case by a remarkable movement of the actuating mechanism. Thereby the method according to the invention can be performed with a door handle unit according to the invention according to claims 1 to 16.

Further features and advantages of the present invention result from the claims, the subsequent description and the drawings. Likewise, the disclosed features from the door handle unit according to the invention also apply for the method according to the invention and vice versa. In the drawings, the invention is shown in diverse embodiments. Thereby the features described in the claims and in the description can each individually or in any combination be essential for the invention. It is shown:

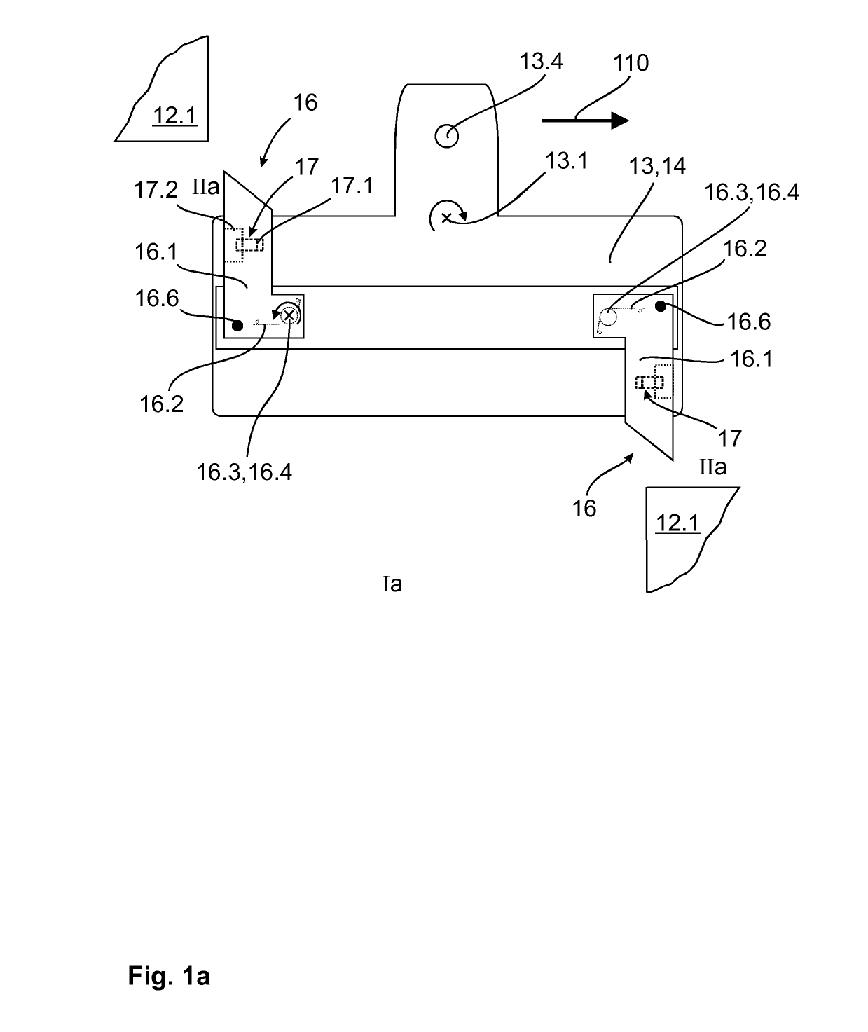

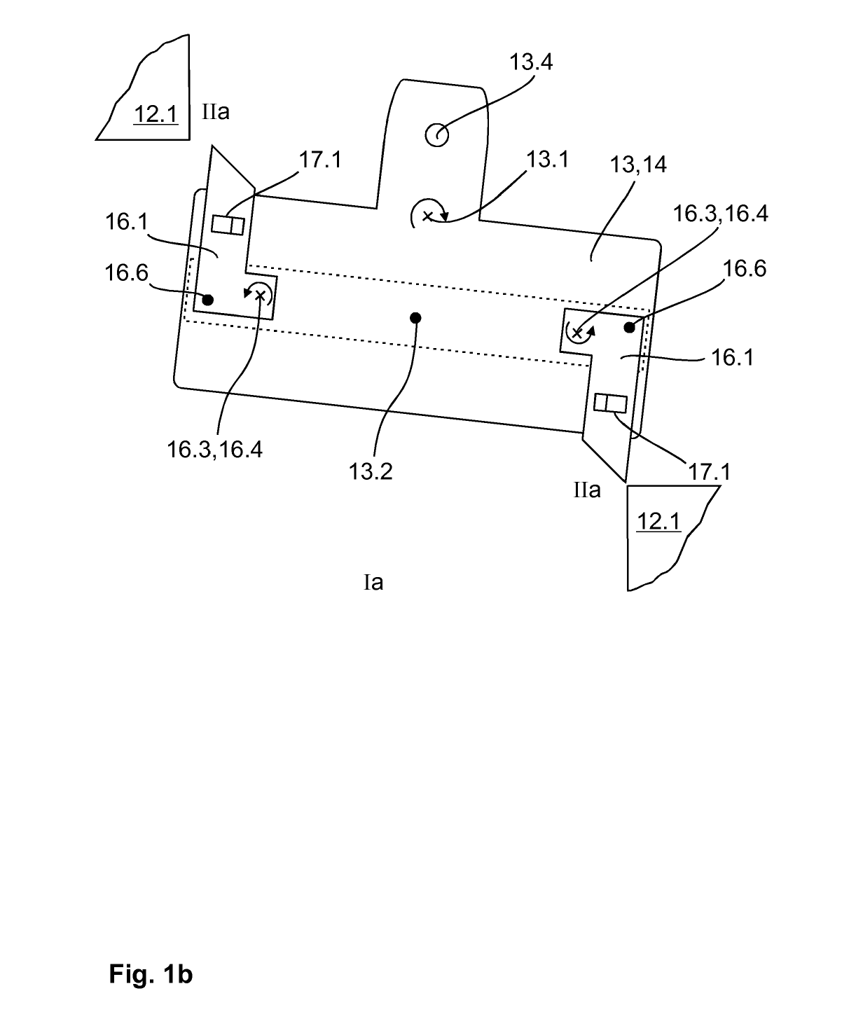

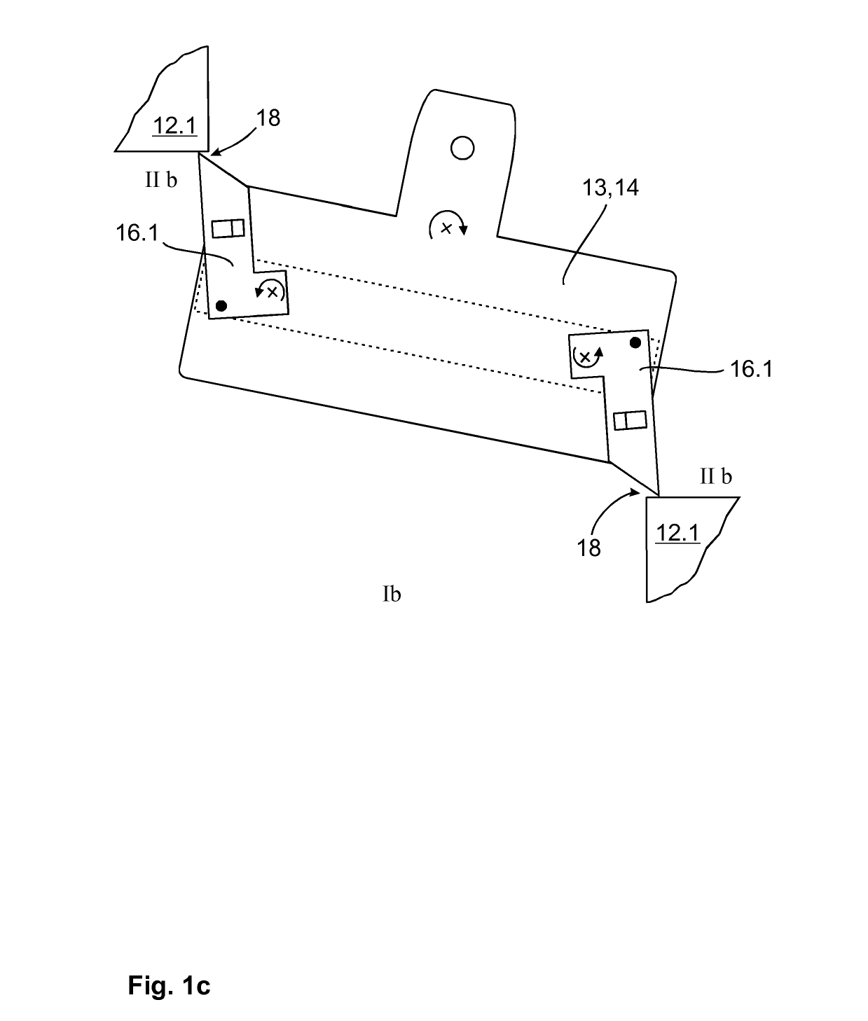

FIG. 1a a schematic drawing of a blocking unit at a door handle unit according to the invention during the normal case and in a releasing position of the blocking unit,

FIG. 1b a comparable drawing of the blocking unit from FIG. 1a during a normal actuation of the door handle unit, so that the blocking unit remains in a releasing position,

FIG. 1c a comparable drawing to FIG. 1b wherein however the blocking case of 1b occurs by a remarkable movement at the actuating mechanism and the blocking unit is assembled in a blocking position,

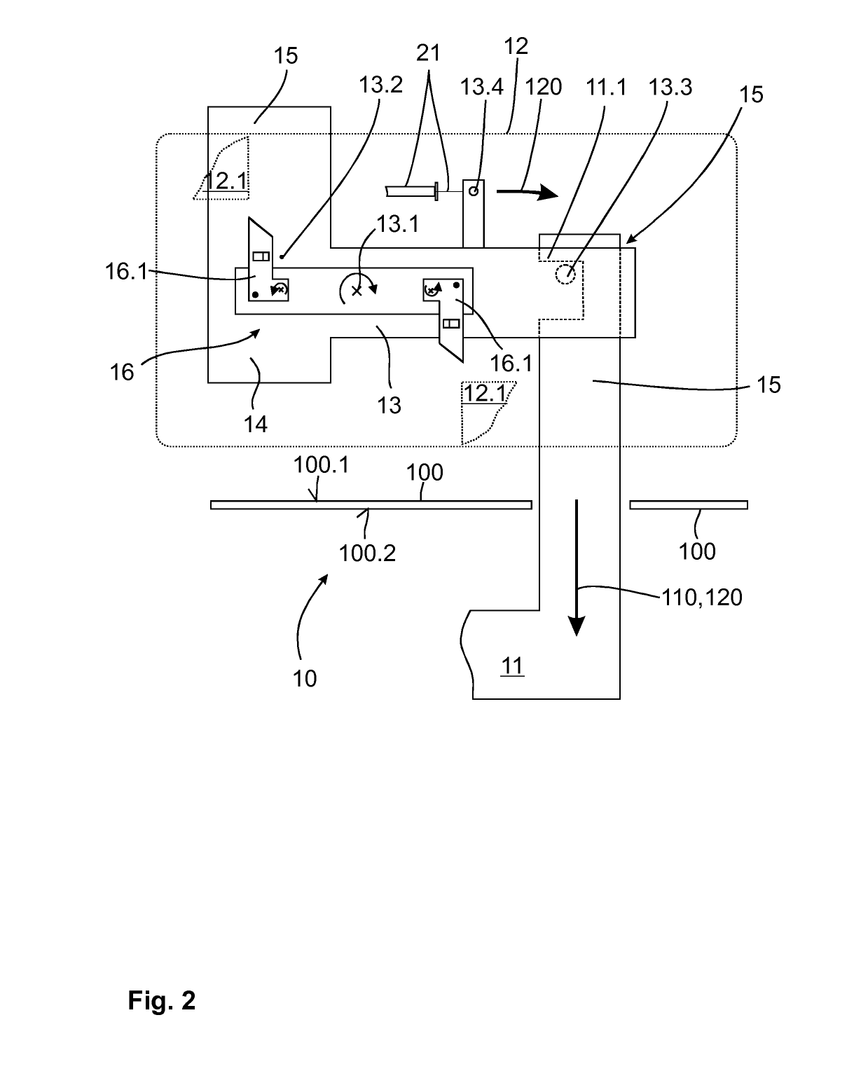

FIG. 2 a schematic drawing of the door handle unit according to the invention with a modular assembled blocking unit in releasing position,

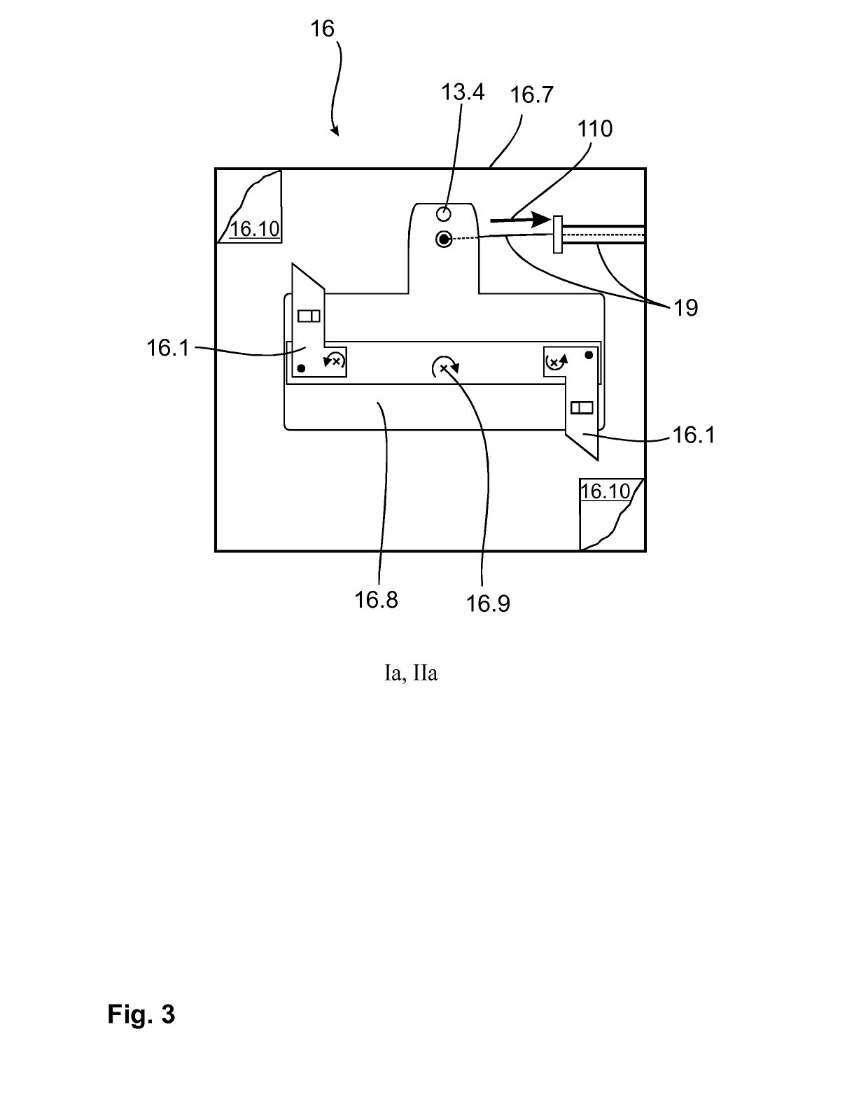

FIG. 3 a schematic drawing of a blocking unit, which can be indirectly assembled at the door handle unit and connected via a transmission element,

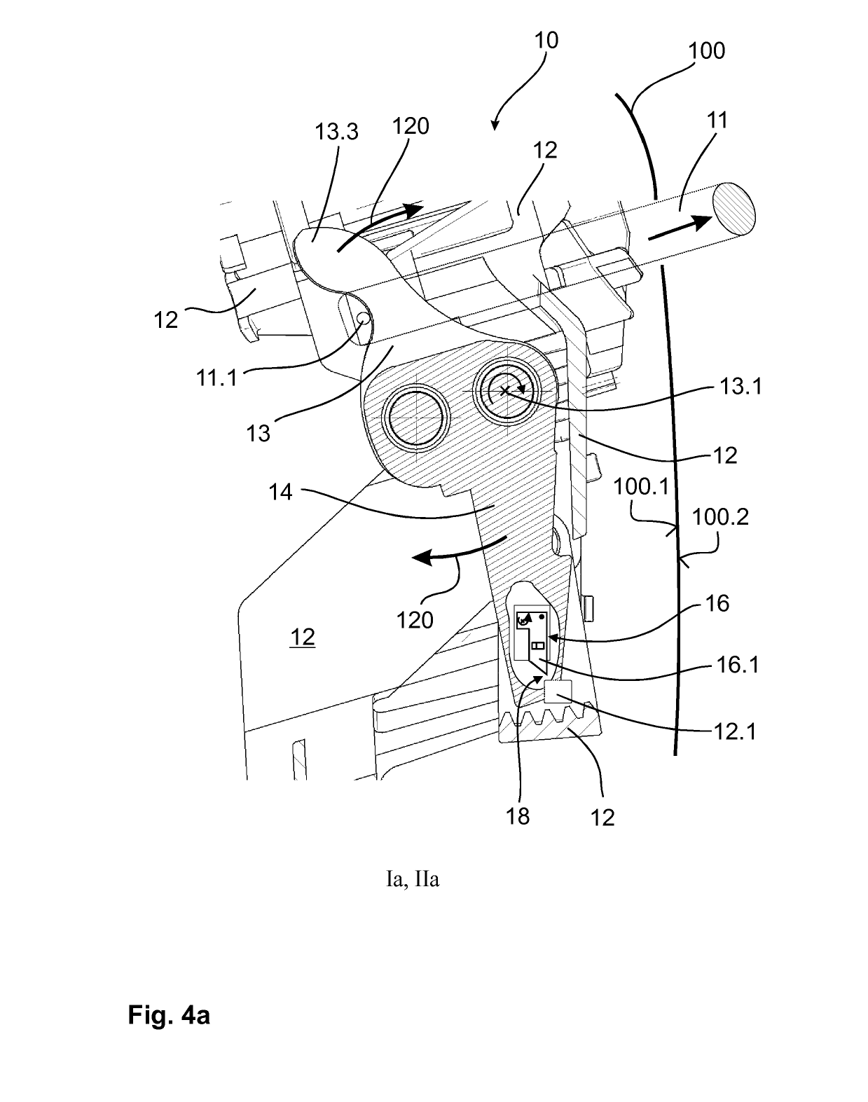

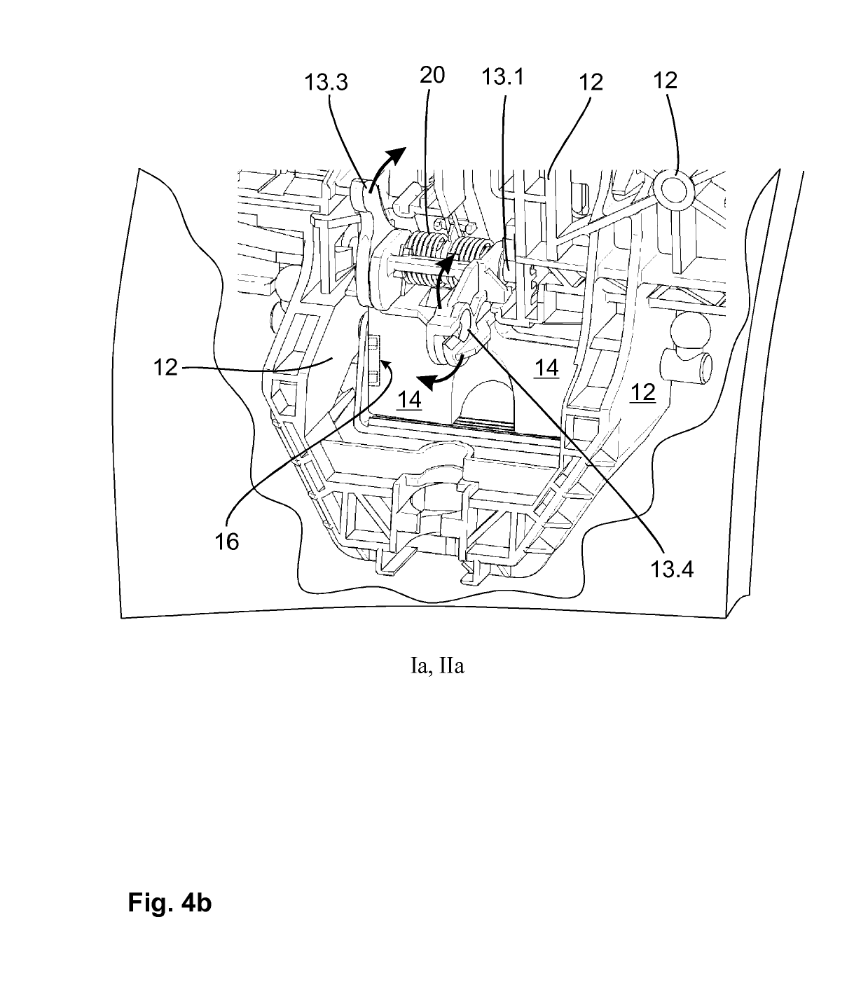

FIG. 4a a sectional view through a door handle unit according to the invention with a modular assembled blocking unit at the counter balance weight in its releasing position,

FIG. 4b a 3-dimensional view of a comparable door handle unit from FIG. 4a with a left handed blocking unit at the counter balance weight with two block latches, and

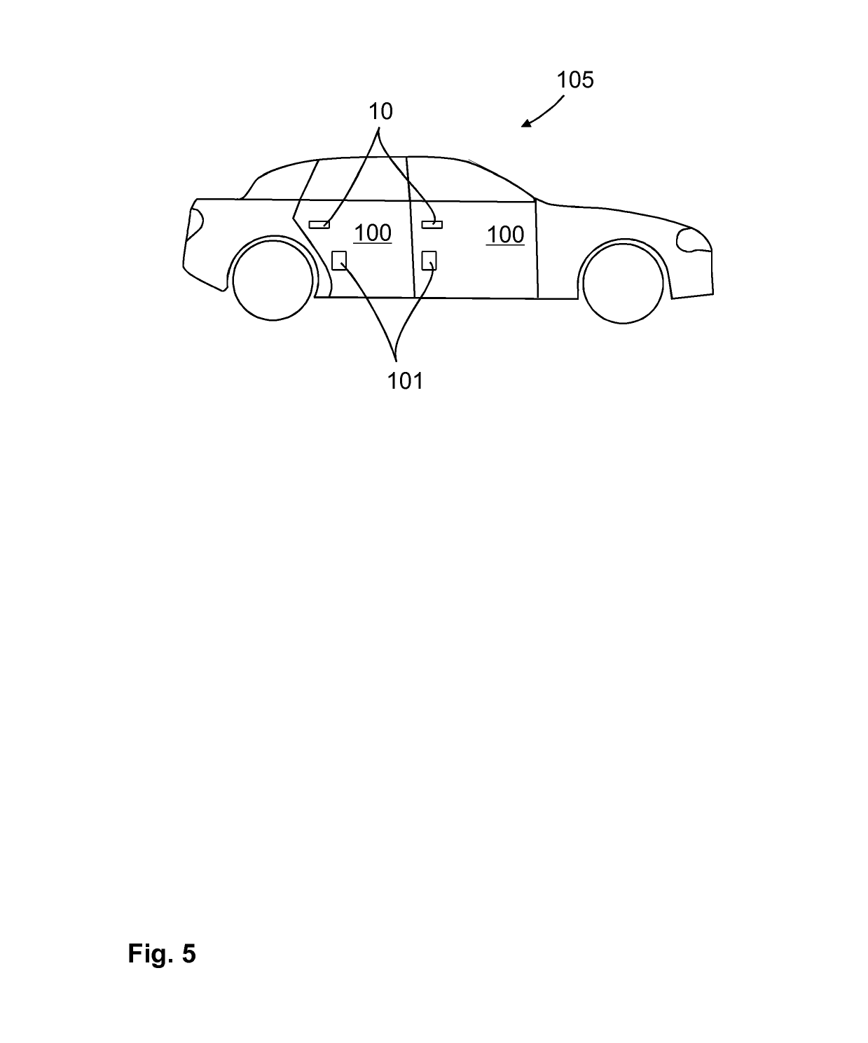

FIG. 5 a schematic drawing of a motor vehicle with a door handle unit according to the invention.

In the figures identical reference numbers are utilized for the same technical features also in different embodiments.

In FIGS. 1a to c the functionality of the door handle unit 10 according to the invention is schematically shown. Thereby FIG. 1a shows a coupling element 13 of the actuating mechanism 15 which is pivotably mounted about a pivot axis 13.1. Additionally an acceptance 13.4 is intended at the coupling element 13 wherein a release means 21, which is shown in FIG. 2 as a Bowden cable and serves as a transmission means for the lock 101, can be mechanically coupled for the mechanic actuating of the lock 101. By a rotation of the coupling element 13 about the pivot point 13.1 an actuation of the release means 21 occurs, whereby the lock 101 is mechanically actuated wherein a movable part 100 can be opened, which is shaped as a door flap or such at a motor vehicle 100. The coupling element 13 can be supplied with a counter balance weight 14 like shown in FIG. 2. Further it is possible that, however, the coupling element 13 represents a separate component for the counter balance weight element 14. The counter balance weight 14 serves for balancing or at least partially compensating the appearing mass inertia forces, which act on the door handle unit 10, particularly the movable door handle 11 during a crash, in order to prevent during a crash of the motor vehicle that the door handle 11 undesirably moves from the resting position in the operating position via the acting acceleration forces of the crash.

In FIGS. 1a and 1b the normal case Ia with a normal appropriate actuating of the door handle 11 is shown and thereby the produced movement of the actuating mechanism 15 with the coupling element 13 and, if necessary, the counter balance weight block 14. In this normal case Ia also the blocking unit 16 according to the invention is in its release position IIa, in which the blocking unit 16 is quasi inoperable, and a movement of the actuating mechanism 15 for actuating the lock 101 is unhindered possible. Based on FIG. 1a, in which the pivotably mounted coupling element 13 is in a resting position of the door handle 11 this coupling element 13 turns by an actuation of the door handle 11 between the resting position and the operating position about the pivoting point 13.1, whereby the coupling element 13 utilizes this pivoting movement for actuating the lock 101. With this rotation of the coupling element 13 in the normal case the blocking unit 16 remains quasi inoperable meaning it is not activated. In contrast to both FIGS. 1a and 1b, in FIG. 1c a comparable drawing of the coupling element 13 is shown, in which the rotation movement is formfittingly 18 blocked by both available blocking units 16. Thereby a further rotation of the coupling element 13 about the pivoting point 13.1 is not further possible, since both available blocking units 16 block this further rotation by the generated formfit 18.

Like shown in FIGS. 1a to c it is further shown in the present case of the door handle unit 10 according to the invention a total of two blocking units 16 being spaced apart to the pivoting point 13.1 the coupling element 13 is assembled. These two blocking units 16 comprise approximately the same distance to the pivoting point 13.1 in the present case and are assembled at different sides of the coupling element 13. A blocking unit 16 comprises itself a pivoting or swinging blocking latch 16.1, which is directly mounted with the coupling element 13 via a pivoting axis 16.4. In the FIGS. 1a and 1b the particular blocking latches 16.1 of the blocking unit 16 are shown in its releasing position IIa. Moreover, in FIG. 1a each a spring element 16.2 for the respective blocking latch 16.1 is drawn. This spring element 16.2 performs a spring force to the blocking latch 16.1 in order to force it into the releasing position IIa. According to FIG. 1a the spring element 16.2 is shaped as a coil spring, which mechanically cooperates with the corresponding stops at the coupling element 13 and the respective blocking latch 16.1. Additionally, in FIGS. 1a to 1c also optional locking connections 17 are shown between the respective blocking latch 16.1 and the coupling element 13. This locking connection 17 is for example realized by a notch 17.1 at the blocking latch 16.1, which mechanically or formfittingly cooperates with an opening 17.2 in which the coupling element 13 or the actuating element 15. By a pivoting movement of the blocking latch 16.1 the notch 17.1 slides at the edge of the opening 17.2 until it formfittingly mechanically locks behind the edge of the opening 17.2. Thereby it is not possible anymore for the blocking latch 16.1 to be moved back from the rotated blocking position IIb into the releasing position IIa. Also the additionally intended spring element 16.2 cannot transfer the blocking latch 16.1 from the blocking position IIb into the releasing position IIa via a corresponding spring force. However, the additional spring element 16.2 serves that the blocking latch 16.1 does not unintendedly move from the releasing position IIa in the blocking position IIb.

Like further shown in FIG. 1b, no activation of the blocking unit 16 results from an appropriate actuation of the door handle 11. In this normal case Ia only a usual movement of the actuating element 15 occurs. In this case the blocking unit 16 remains inactive and persists in its releasing position IIa. Like shown according to FIG. 1b the tapered edges of the L-like blocking latch 16.1 move thereby at provided outlets 12.1 and without contacting these. The outlets 12.1 are stationally assembled at the support element 12 or the movable part 100 and formfittingly act with the respective blocking latch 16.1 in the blocking position IIb. Like already said, both L-like blocking latches from FIG. 1b remain in their releasing position IIa and thereby are not contacting the intended outlets 12.1, so that altogether the blocking unit 16 remains inactive.

In FIG. 1c the coupling element 13 is shown, which performs a part of the movable actuating mechanism 15 with a remarkable movement of the actuation element 15. With this remarkable movement the actuating mechanism 15 turns with a certain speed so that a corresponding resulting releasing force 110 acts from the available centrifugal force to the pivotably mounted blocking latches 16.1. By the releasing force 110 the respective blocking latch 16.1 is pivoted about its pivot point 16.3 or the therefore intended pivot axis 16.2 until its blocking position IIb. In this blocking position IIb a blocking latch is particularly formfittingly kept via a stop element, so that a further turning of the blocking latch 16.1 beyond the blocking position IIb is not possible. Due to the low mass of the respective blocking latch 16.1 these are immediately turning about its pivoting axis 16.3 once a remarkable movement of the actuating mechanism 15 occurs.

Like shown in FIG. 1c it can be further recognized that the turned blocking latches 16.1 correspond in their blocking position IIb in a formfitting way with the respective intended outlets 12.1 at the support element 12. Thereby a formfit 18 between the blocking latches 16.1 in the blocking position IIb and the outlets 12.1 is performed. Due to the formfit the actuating mechanism 15 cannot be further turned whereby also an actuation of the mechanic lock 101 is not possible anymore since the previous movement of the actuation mechanism 15 is not sufficient in order to actuate the lock 101. In this way it is ensured that an undesired opening of the lock 110 is securely prevented by the present blocking unit 16. Due to the optional intended locking connection 17 it can be additionally achieved that the block latch 16.1 cannot anymore be transferred from its blocking position IIb to the releasing position IIa. The previously described functionality of the blocking unit 16 according to the invention with the blocking latch 16.1 with the cooperation with the outlet 12.1 is similar in each embodiment so that in the following it is not newly described.

In FIG. 2 it is only schematically shown the door handle unit 10 according to the invention with its essential elements and components. Thereby the movable door handle 11 is shaped as a pulling handle in the direction of the arrow 120. However, this movable door handle 11 can also be an actuation recess or a pivoting pull handle or such. The movement of the door handle 11 is transferred via an outlet 11.1 at the door handle 11 to an actuator 13.3 of the coupling element 13. Hereby a turning of the coupling element 13 about the pivot axis 13.1 or the pivot point 13.1 is generated. This pivot point can also be the center between both pivot points 16.3 or both blocking units 16. In the present case the blocking unit 16 is shaped modular and is assembled in a recess in the coupling element 13. Thereby both blocking latches 16.1 extrude laterally from the recesses of the coupling element 13 in order to generate the desired formfit 18 with both outlets 12.1 of the support element 12 in a blocking case Ib. The whole door handle unit 10 is assembled via the support element 12 at the movable part 100, particularly at the internal side 100.1. Thereby also both outlets 12.1 from the support element 12 are stationary, particularly independent from the actuating mechanism 15 or the coupling element 13 at the door handle unit 10. The corresponding pivot axis 16.4 for the blocking latch 16.1 of the blocking unit 16 can at the same time serve as holding elements 16.5 for the modular assembled blocking unit 16. For example at present screws can serve as holding elements 16.5 and pivot axes 16.4. The functionality of the corresponding blocking unit 16 is previously described in detail. Like further shown in FIG. 2, a pull movement at the door handle 11 in the direction of the arrow 120 leads to a turning of the coupling element 13 to a clockwise turning of the coupling element 13 about the pivot point 13.1. Hereby the releasing means 21 for the lock 101 is pulled through the corresponding assembly 13.4 at the support element 12 in the direction of the arrow 120. Thereby in the normal case la the mechanic lock 101 can be opened by an actuation of the door handle 11 from its rest position to its operating position.

In FIG. 3 a further embodiment of the door handle unit 10 according to the invention is shown. Hereby the blocking unit 16 is indirectly connected via a transmission element 19 with the actuating mechanism 15 with which it mechanically cooperates. In this case the blocking unit 16 can be assembled at the support element 12 or the movable part 100. Particularly the blocking unit 16 is placed within the housing 16.7, in which each an outlet 16.10 for the blocking latches 16.1 is intended. This outlet 16.10 can be a part of the housing 16.7 or the support element 12 or the movable part 100. The particular at the present blocking unit 16 from FIG. 3 is to be seen in the fact that this can be coupled as a separate component at an available door handle unit 10 via the transmission element 19. Additionally the acceptance 13.4 for the releasing means 21 can also come off from the rocker-like 16.8 shaped blocking unit 16 in order to block the mechanical transmission for the lock 101. The transmission element 19 is shown in FIG. 3 for example as a Bowden cable. With this embodiment it is also possible that between the actuation element 15 and the separate blocking unit 16 a gear is interconnected in order to achieve a specific transmission relation. Like previously described this gear can be performed as a lever gear or as a wheel gear or such like in order to generate the desired transmission relation. With the separate blocking unit 16 a pivotable rocker 16.8 is applicable, which is ideally pivotable about its center of mass 16.9 as a pivoting point. Further, with preferably the same distance two blocking latches 16.1 are assembled to the pivoting point 16.3 or the center of mass 16.8. Both blocking latches 16.1 are also pivotable at the T-like rocker 16.8 assembled in order to achieve the desired formfit 18 with the previously described outlet 16.10 in the blocking case Ib.

In further FIGS. 4a and 4b a detailed shape of the door handle unit 10 according to the invention with essential details is shown. Thereby the door handle unit 10 comprises a support element 12, which serves for the assembly of the whole door handle unit 10 at the movable part 100. Like recognizable at both FIGS. 4a and 4b the support element 12 is assembled at the internal side 101 of the movable part 100 and the movable door handle 11 extrudes through an opening in the movable part 100 through the external side 102. At the stably assembled support element 12 a pivotable coupling element 13 is assembled via a pivoting point 13.1. At the same time this coupling element 13 comprises a center balance weight 14 so that both components represent an integral element. The complete form of the integral coupling element 13 is lever-like or rocker-like, whereby the upper area above the pivoting point 13.1, serves as an actuator 13.3 for the movable door handle 11. Hereby a recess at the actuator 13.3 is intended, which formfittingly cooperates with the outlet 11.1 of the door handle 11. In the lower area the coupling element 13, which lies underneath the pivoting point 13.1, is a blocking unit 16 according to the invention with exactly one blocking latch 16.1, which functionally cooperates with an outlet 12.1 of the support element 12 in the blocking case Ib. In FIG. 4a also each the blocking unit 16 according to the invention can be intended coming from different sides of the coupling elements 13 in order to increase the stability and safety of the door handle unit 10 according to the invention. In FIG. 4a also the respective movement directions 120 for the movable door handle 11 or the thereby resulting pivot movements of the coupling elements 13 are shown.

In a further FIG. 4b a 3-dimensional view of the door handle unit 10 from FIG. 4a but without the movable door handle 11 is shown. For a better clarification also the blocking unit 16 according the invention is shown with a dashed line at the left side of the coupling element 13. Also at the right side of the coupling element 13 a corresponding blocking unit 16 can be assembled, which is optically concealed by the support element 12. Likewise in FIG. 4b also the acceptance 13.4 for the release means 21 is shown.

In the FIGS. 4a and 4b the actuating mechanism 15 with the door handle 11 is in its resting position. Also the blocking unit 16 according to the invention is shown in the releasing position IIa in the normal case Ia.

In FIG. 5 a vehicle as a motor vehicle 105 is shown in a lateral view. Thereby both lateral doors are clearly recognizable, which each represent a movable part 100. Likewise the therefore intended locks 101 underneath the door handle unit 10 according to the invention are shown at the lateral doors. By the door handle unit 10 according to the invention a movement of the actuating mechanism 15 for actuating the lock 100 is reliably blocked in the blocking case.

### LIST OF REFERENCE NUMBERS AND CORRESPONDING PARTS

10 door handle unit
11 door handle
11.1 paragraph for 13.3
12 support element
12.1 paragraph for 18 respectively 16
13 coupling element
13.1 pivot point/pivot axis
13.2 center of mass
13.3 an actuator for 11
13.4 the acceptance for 21
14 center balance weight
15 mechanism
16 blocking unit
16.1 blocking latch
16.2 spring element
16.3 pivot points
16.4 pivot axis
16.5 holding elements
16.6 center of mass
16.7 housing
16.8 rocker
16.9 center of mass of 16.8
16.10 outlet at the housing
17 rest connection
17.1 the notch to 16.1
17.2 the opening in 15
18 formfit, formfitting
19 transmission element
20 spring element for 13, 14
21 releasing means for 101
100 movable part
100.1 internal side
100.2 external side
101 the lock
105 vehicle
110 for actuating the lock
120 arrow for movement direction
Ia normal case
Ib case of blocking
IIa release position
IIb blocking position

1. Door handle unit (10) for actuating a lock (101) of a movable part (100) of a motor vehicle (105), particularly a door, a flap or the like, with a door handle (11), which is movably mounted at the support element (12) for mechanically opening the movable part (100) by a user, wherein the door handle (11) comprises at least a rest position and a operative position, a mechanical coupling element, which is movably mounted at the support element (12) and by which a movement of the door handle (11) is transmitted from the rest position to the operating position to the lock (101), wherein the door handle (11) and the coupling element (13) are mechanically cooperating and form a movable actuating mechanism (15), and at least a locking unit (16), which in normal case (Ia) enables a movement of the actuating mechanism (15) for actuating the lock (101) and only in the case of locking (Ib) blocks the movement of the actuating mechanism (15) for actuating the lock (110),
characterized in that,
the blocking unit (16) can be activated for the case of blocking (Ib) via a remarkable movement of the actuating mechanism (15).

2. Door handle unit (10) according to claim 1,
characterized in that,
the blocking unit (16) comprises at least one movable blocking latch (16.1), which formfittingly (18) blocks the actuating mechanism (15) in case of blocking (Ib), wherein particularly the formfitting (18) between the blocking latch (16.1) and the support element (12) or the movable part (100), particularly an outlet (12.1) or projection thereof, is available.

3. Door handle unit (10) according to claim 1,
characterized in that,
each blocking latch (16.1) of the blocking unit (16) comprises a release position (IIa), in which the blocking latch (16.1) is in the normal case (Ia), and the blocking position (IIb), in which the blocking latch (16.1) is in the case of blocking (Ib), whereby each blocking latch (16.1) can be traversed from the release position (IIa) into the blocking position (IIb), and wherein particularly the releasing direction of each particular releasing force (110) partly varies from one another of at least two blocking latches (16.1).

4. Door handle unit (10) according to claim 1,
characterized in that,
at least a blocking latch (16.1) is spring-loaded mounted in release position.

5. Door handle unit (10) according to claim 1,
characterized in that,
at least a blocking latch (16.1) comprises a fixed pivot point (16.3) from the blocking unit (16) and the blocking latch (16.1) is pivotable between the release position and the blocking position.

6. Door handle unit (10) according to claim 1,
characterized in that,
the rotation of the blocking latch (16.1) from a release position (IIa) into a blocking position (IIb) occurs in case of blocking via a remarkable movement of the actuating mechanism (15), wherein particularly the blocking unit (16) mechanically moves with the actuating mechanism (15).

7. Door handle unit 10 according to claim 1,
characterized in that,
at least one blocking latch (16.1) of the blocking unit (16) mechanically connects via the rest connection (17) in the blocking position (IIb) during a change from the release position (IIa) to the blocking position (IIb).

8. Door handle unit (10) according to claim 1,
characterized in that,
a remarkable movement of the actuating mechanism (15) depends on our fitful and/or fast movement.

9. Door handle unit (10) according to claim 1,
characterized in that,
the blocking unit (16) blocks in case of blocking (Ib) the actuating mechanism (15) by at least a formfitting (18), wherein particularly at least a blocking latch (16.1) formfittingly blocks the actuating mechanism (15) in case of blocking (IIb).

10. Door handle unit (10) according to claim 1,
characterized in that,
the blocking unit (16) mechanically blocks in case of blocking (IIb) via the rest connection (17) in a way that the actuating mechanism (15) is permanently blocked by formfitting (18).

11. Door handle unit (10) according to claim 1,
characterized in that,
the blocking unit (16) is directly assembled at the actuating mechanism (15) wherein particularly the formfitting (18) occurs in case of blocking (Ib) by at least one blocking latch (16.1), which is assembled between the movable actuating mechanism (15) and the support element (12) or the movable part (100).

12. Door handle unit (10) according to claim 1,
characterized in that,
the blocking unit (16) mechanically cooperates with the actuating mechanism (15) indirectly via a transmission element (19) wherein particularly the blocking unit (16) is assembled at the support element (12) or the movable part (100).

13. Door handle unit (10) according to claim 1,
characterized in that,
the blocking unit (16) mechanically cooperates with the actuating mechanism (15) via a transmission element (19) wherein particularly the transmission element (19) comprises a transmission ratio and is particularly performed as a gear.

14. Door handle unit (10) according to claim 1,
characterized in that,
the blocking unit (16) comprises a modular composition wherein the whole locking unit (16) can be mounted simply and completely at the door handle unit (10) wherein particularly the modular composed blocking unit (16) comprises at least one particularly spring loaded (16.2), movable blocking latch with particularly a fixed pivot axis (16.4) for a fixed pivot point (16.3) wherein the pivot axis (16.4) is assembled at a holding element (16.5) of the blocking unit (16) and the holding element (16.5) serves for the assembly of the blocking unit (16) at the door unit (10) or the movable part (100).

15. Door handle unit (10) according to claim 1,
characterized in that,
the counter balance weight (14) is intended for counterbalance weight of the actuating mechanism (15), which is particularly stably assembled to the coupling element (13) and wherein particularly the blocking unit (16) can be directly assembled at the counter balance weight (14).

16. Door handle unit (10) according to claim 1,
characterized in that,
at least a blocking latch (16.1) can be transferred from the release position (IIa) into the blocking position (IIb) by a releasing force wherein particularly the releasing force results of an extraordinary movement of the actuating mechanism (15), which leads to a swing and pivot movement of the blocking unit (16) and particularly a centrifugal force, which depends on the blocking unit (16) particularly the blocking latch (16.1).

17. Method for securing a door handle unit (10) for actuating a lock (101) of a movable part (100) of a motor vehicle particularly a door, flap or such with a door handle (11), which is pivotally mounted at a support element (12) for mechanically opening the movable part (100) by the user wherein the door handle unit (10) comprises at least one rest position and one operating position, a mechanical coupling element (13), which is movably mounted at the support element and via which a movement of the door handle (11) can be transferred from the rest position to the operating position of the lock (101) wherein the door handle (11) and the coupling element (13) are mechanically cooperating and form of movable actuating mechanism (15) and at least a blocking unit (16), which in the normal case enables a movement of the actuating mechanism (15) for actuating the lock (101) and only in case of blocking (Ib) blocks a movement of the actuating mechanism (15) for actuating the lock (101), characterized in that,
the blocking unit (16) for a case of blocking (Ib) activates the actuating mechanism (15) by an extraordinary movement.

18. Method for securing a door handle unit (10) according to claim 17,
characterized in that,
the method is performed with the door handle unit (10) according to the invention.
